(19) United States
(12) Patent Application Publication
(10) Pub. No.: US 2017/0155683 A1
(43) Pub. Date: Jun. 1, 2017

(54) REMEDIAL ACTION FOR RELEASE OF THREAT DATA

(71) Applicant: HEWLETT PACKARD ENTERPRISE DEVELOPMENT LP, Houston, TX (US)

(72) Inventor: Anurag SINGLA, Sunnyvale, CA (US)

(21) Appl. No.: 15/328,015

(22) PCT Filed: Jul. 21, 2014
(86) PCT No.: PCT/US2014/047364

§ 371 Date: Jan. 20, 2017

(51) Int. Cl. H04L 29/06; G06F 21/60

(52) U.S. Cl. CPC H04L 63/20; G06F 21/604

(57) ABSTRACT

Example embodiments disclosed herein relate to performing a remedial action based on the release of data. Threat information is received from multiple threat submitters. Data about the respective threat information is provided to a plurality of entities based on rules. It is determined that the data has been released outside of the entities. The remedial action is performed based on the release of the data.

### BACKGROUND

Entities can maintain internal networks with one or more connections to the Internet. Internal networks include multiple resources connected by communication links, and can be used to connect people, provide services—both internally and externally via the Internet—and/or organize information, among other activities associated with an entity. Resources on the network can be susceptible to security attacks that originate either within the internal network or on the Internet. A security attack can include an attempt to destroy, modify, disable, steal, and/or gain unauthorized access to use of an asset (e.g., a resource, data, and information).

### BRIEF DESCRIPTION OF THE DRAWINGS

The following detailed description references the drawings, wherein:

FIG. 1 is a block diagram of a computing system capable of performing a remedial action based on release of threat data, according to one example;

FIGS. 2 and 3 are block diagrams of threat platforms capable of remediation of release of threat data, according to various examples;

FIG. 4 is a flowchart of a method for performing a remedial action based on release of threat data, according to one example;

FIG. 5 is a block diagram of a computing system capable of remediating a release of threat data, according to one example; and

FIG. 6 is a flowchart of a method for identifying a potential source of release of threat data, according to one example.

### DETAILED DESCRIPTION

Entities can seek to avoid security attacks by identifying vulnerabilities in their networks. A vulnerability can include a flaw and/or weakness in the network's design, implementation, operation, and/or management that could be exploited to violate the network's security policy (e.g., a circumstance and/or event with the potential to adversely impact a network through unauthorized access, destruction, disclosure, and/or modification of an asset of the entity). An exploit can include computer-readable instructions, data, and/or a sequence of commands that takes advantage of a vulnerability to cause unwanted and/or unanticipated behavior. A security attack can include a use and/or attempted use of an exploit against a vulnerability. To avoid subsequent security attacks, an entity can perform an investigation (e.g., forensic investigation) to determine what exploits were used against what vulnerabilities during the security attack.

It can be beneficial for an entity to identify current security threats to a network associated with the entity, to information held by the entity, and/or to resources managed by the entity (e.g., computing devices, memory resources, processing resources). A security threat can include information that indicates the possibility of an impending security attack. The information can include information indicating a vulnerability and/or exploit, and/or information that an attack has occurred to another entity, among other information.

Entities face increasingly sophisticated, professional, organized, and well-funded security attacks on their information technology (IT) infrastructures. By quickly and accurately detecting, identifying, and/or addressing security threats, an entity may mitigate the effects of these security attacks. However, entities may find it increasingly difficult to quickly and accurately detect, identify, and/or address these security threat alerts on their own. Entities may currently identify security threat alerts by accessing a plurality of threat intelligence sources. The threat intelligence sources can, however, provide a vast amount of information and can result in a flood of security threats, most of the time without context. The security threats can lead to false positive security alerts that may take human resources to analyze and resolve. Encouraging entities to share information relating to security threats may improve the speed and/or accuracy in detecting emerging threats in part by adding context around the threat.

Entities can participate in a threat exchange community to identify security threats. For instance, a threat exchange community can include a group of computing systems that exchange information (e.g., data) related to information technology infrastructures (e.g., systems and services) via communication links. The computing systems can be referred to as participants of the threat exchange community. In some implementations, entities including and/or controlling the computing systems can also be referred to as participants of the threat exchange community. In some examples, a threat submitter is a participant in the threat exchange community that provides threat data. Further, in some examples, threat submitters may be considered one of the entities that receives data in the threat exchange community.

However, entities may wish to restrict access to information the respective entities share to certain members, for example, members of a particular community. For example, a banking member may wish to restrict their data shared to other banking members and/or the government. The entities may not wish to share with other entities because for various reasons, for example, they may not trust those entities, they may wish to share to provide others with the ability to help, but not for use by others. Examples of communities may include health care, small businesses, government, car manufacturers, banking, financial, etc.

Information leakage can be an issue in a security indicator or threat exchange platform. Even though system performs reliable and accurate sharing of the security indicators based upon sharing policies of the submitter, the receiver of the information may be able to leak it to other communities or externally, even if prohibited by policy. In other words, even though the system performs reliable and accurate sharing of the security indicators based on sharing policies and/or rules of a submitter, the receiver of the information may leak it to other communities and/or externally, even if prohibited by policy. Thus, the ability to detect the information leakage can be beneficial to preserve the confidentiality of the shared information as well as maintain trust of the participants in the sharing platform.

Accordingly, various embodiments disclosed herein relate to detection of information leak from a security information sharing platform. The threat exchange platform can detect patterns where information released in a community becomes available to other communities or public after some time. When information is shared in a new community, the system can check the details of the communities where it was previously shared. It could be a potential leak of information from existing communities or could be a legitimate share.

If such pattern of sharing is observed (e.g. information shared in community A becomes available to community B repeatedly after few hours etc.), it may be due to potential information leak. Intelligence feeds, such as open source intelligence feeds as well as public information on internet can also be observed in addition to communities of the threat exchange platform to identify possible information leak.

If leak is suspected, various approaches can be used to detect a source of the leak. The following are examples of some of the techniques that will be used to identify possible entities leading to leak, intentionally or unintentionally (e.g. due to virus on their systems, rogue employee, or not having stronger data protection controls, etc.). In one example, the system can check if information was shared by original submitter, which can be an automatic check by the system and/or a manual check through email or other means (e.g., contacting the submitter).

In another example, the system can start selective sharing by eliminating x% of participants from a shared information pool to see if the sharing happens. This can be used to identify the entities that may be responsible for the information leak by mapping times when the information is leaked with the participants that were provided the information. Additional participants can be eliminated from a set of the participants associated with a possible leak. As such the system can share a different k% of information with the participants to identify specific entities leading to leak of information. This can continue iteratively until a source for the leak is determined.

In another example, the system can generate random security indicators and share it with the participants and watch out for their availability outside of shared community, which would not be expected. As such, tainted information can be provided (e.g., a different set of information to different members of the community). The taint can be a mark or signature (e.g., a made up threat at a particular IP address) that particular information was provided to the respective participants. Different taints can be set for different members. If the leak passes through and is released outside of the community (e.g., to another community or feed) a correlation can be drawn between the member associated with the particular taint and the leaks. In certain examples, release of information is the providing of submitted information outside of the set policy or rule for the community.

In a further example, to find correlations between what is being released and participants receiving the information, the information of multi-step attacks can be separated and participants can be provided varying versions of the multi-step attack. For example, if a multi-step attack has parts A, B, C, D, E, one participant may receive A, B, C, D, while another receives A, B, C, E, and another receives B, C, D, E. In some examples, each can be used to signify that the attack is occurring and are thus usable, but if a variation is leaked, the variation can be used as a signature to identify the participant that may be responsible for the release of information because it is not expected that this information gets shared in the same partial form in another community or externally.

Participants of the threat community can be rated based on automated tracking of utilization of the submitted security indicators in Security Information Event Management (SIEM) Systems. In one example, a threat management platform will monitor the usage of provided data through Rules in a SIEM system in an automated way.

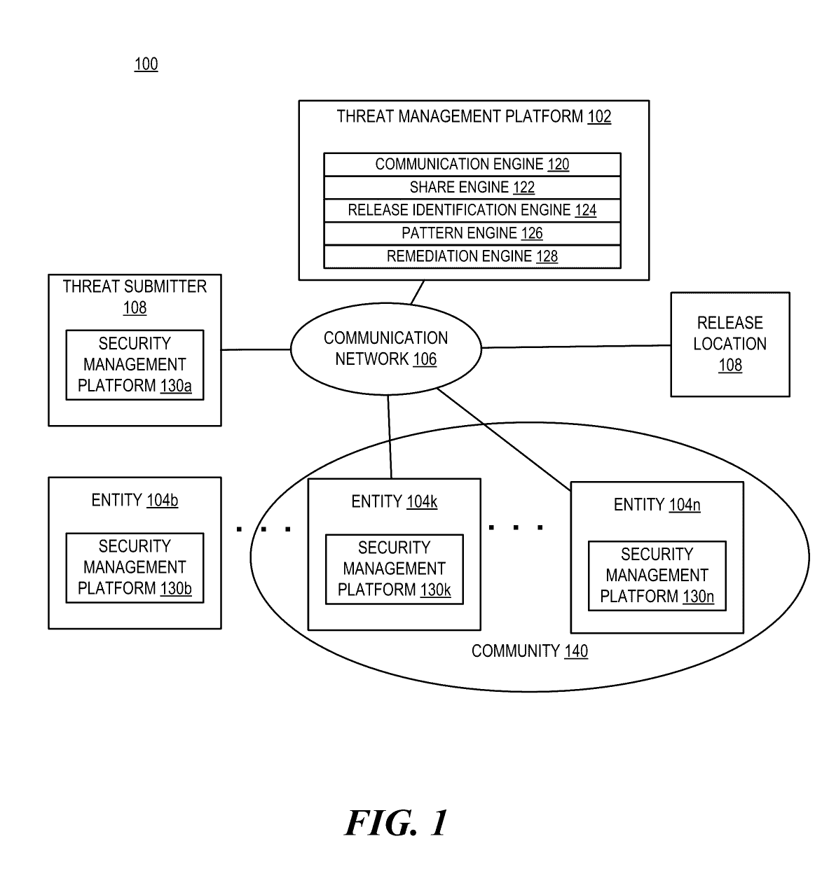

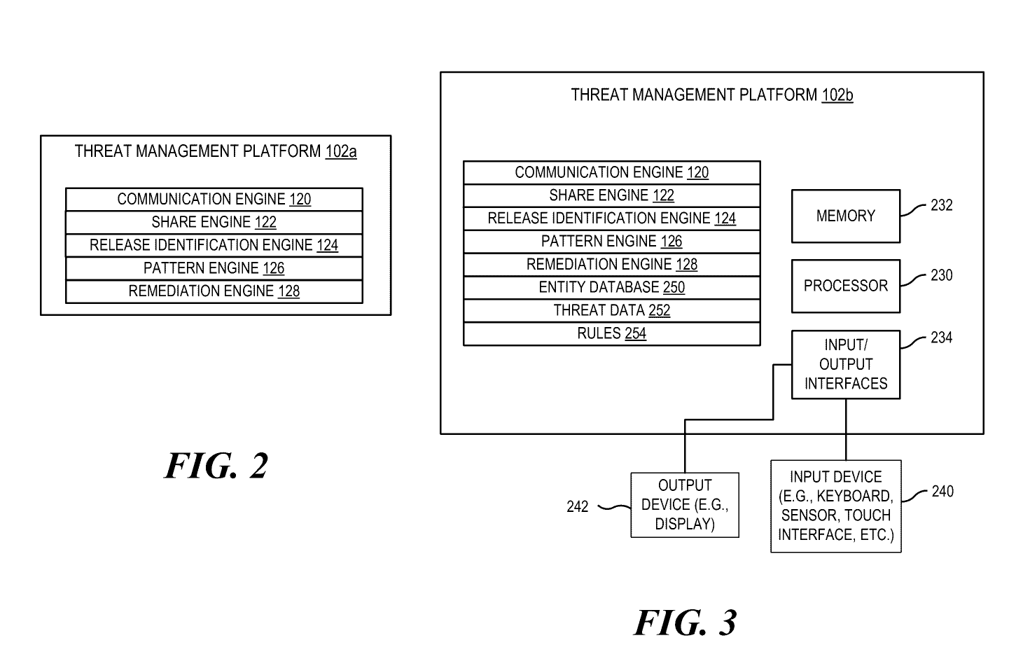

FIG. 1 is a block diagram of a computing system capable of performing a remedial action based on release of threat data, according to one example. FIGS. 2 and 3 are block diagrams of threat management platforms 102 capable of remediation of release of threat data, according to various examples. The system 100 can include a threat management platform 102 that communicates with entities 104a-104n via a communication network 106. Functionality of threat management platform 102 may be implemented as a single computing device and/or be split between multiple computing devices. One or more of these entities can be considered a threat submitter 108. In certain examples, the threat management platform 102 and/or the entities 104a, 104b-104k-104n, 108 can include security management platforms 130a, 130b-130k-130n that are implemented using computing devices, such as servers, client computers, desktop computers, workstations, security appliances, security information and event management platforms, etc. In some embodiments, the security management platforms 130 can include special purpose machines.

The threat management platform 102a can include a communication engine 120 and/or module, a share engine 122 and/or module, and a release identification engine 124 and/or module, a pattern engine 126 and/or module, and remediation engine 128 and/or module. Further, threat management platform 102b can include an entity database 250, threat data 252, and rules 254. The engines 120, 122, 124, 126, 128, include hardware and/or combinations of hardware and programming to perform functions provided herein. Moreover, the modules (not shown) can include programming functions and/or combinations of programming functions to be executed by hardware as provided herein. When discussing the engines and modules, it is noted that functionality attributed to an engine can also be attributed to the corresponding module and vice versa. Moreover, functionality attributed to a particular module and/or engine may also be implemented using another module and/or engine.

As described herein, the entities 104 and/or threat submitter 108 can be considered participants in the threat exchange community. Participants include a participant server or group of participant security management platform 130 within the IT infrastructure of each entity from a group of entities. Each participant security management platform 130 (or each group of participant servers) can provide information related to actions within or at the IT infrastructure including that participant security management platform 130 to the threat management platform 102.

The threat management platform 102 can analyze information provided by each participant security management platform 130 to identify security occurrences within the threat exchange community, and provide scores related to the threat observables to entities 104. A threat observable is information that can be observed by a device that can be used to make a determination that something (e.g., an event, an action, an IP address, a device, a set of events, a pattern, etc.) is malicious. In some examples, a threat observable can be considered a security indicator. Security indicators include any type of specific or non-specific information related to a security threat. For example, a security indicator may include an Internet Protocol (IP) address related to a security threat. According to another example, a security indicator may include specific information related to a particular type of malware, or any non-specific information related to malware generally. A security indicator may also include any type of parameter or attribute that may be tracked with respect to a security threat. Users of security indicator sharing platforms typically share such security indicators with other users in an effort to advise the other users of any security threats, or to gain information related to a security threat from other users.

In some examples, the threat observables can be based on a security occurrence. A security occurrence, as used herein, can include variables and information (e.g., data) that influence an action by the security management platforms 130. For example, such security occurrences that influence an action can include information describing a security context, a security attack, a security threat, a suspicious event, a vulnerability, an exploit, an alert, an incident, and/or other relevant events, identified using the participant provided information. Information can be correlated into scores for particular threat observables and can be customized to the particular security management platforms 130 of the respective entities 104. Examples of security management platforms 130 include an intrusion detection system, an intrusion prevention system, a security information and event management system, a firewall and the like.

The threat exchange community may also include one or more private communities. Private communities are those communities that threat exchange participants manage by selecting specific entities that are allowed to participate. A threat exchange participant can be a member of one or more private communities in addition to other types of communities. In some examples, indicators and threat data shared within a private community is not shared with other communities.

The plurality of entities 104a-104n can provide participant data to the threat management platform 102. The participant data can include security data and/or characteristic data. In one example, one of the entities is the threat submitter 108.

Security data, as used herein, can include security related information (e.g., IP addresses, host names, domains, URLs, file descriptions, application signatures, patch levels, behavioral descriptions of malware, personally identifiable information (e.g., email addresses, contact information, names, etc.), participant specific security information (e.g., system configurations, locations of participants, etc.), etc.). For instance, security data can include information that describes security occurrences. A security occurrence, as used herein, can include variables and information (e.g., data) that influence an action by the threat management platform. For example, such security occurrences that influence an action can include information describing a security context, a security attack, a security threat, a suspicious event, a vulnerability, an exploit, an alert, an incident, and/or other relevant events, identified using the participant provided information (e.g., the participant data).

Characteristic data can include data related to the participant, such as infrastructure data (e.g., operating systems used, versions of software used, known vulnerabilities associated with particular devices/software used, etc.), industry sector identification (e.g., banking, government, political, IT, etc.), and/or size of the entity, for example. In a number of examples, characteristic data can include historical security data identifying previous security occurrences identified by a participant. This can be used to determine one or more other characteristics of the participant including the credibility of data shared by that participant over time. This can be reflected, for example, in a threat submitter rating.

An event (or security event), as used herein, can include a description of something that has happened. An event may be used to describe both the thing that happened and the description of the thing that happened. For instance, an event can include information such as records within a log associated with the event. Examples of events include, “Alice logged into the machine at IP address 10.1.1.1”, “The machine at IP address 192.168.10.1 transferred 4.2 gigabytes of data to the machine at IP address 8.1.34.2.”, “A mail message was sent from email1 to email2 at 2:38 pm”, “John Smith used his badge to open door 5 in building 3 at 8:30 pm”, or “a new attack campaign has been initiated announcing a future threat”. Events can contain a plurality of detailed data and may be formatted in a way that is computer readable (e.g. comma separated fields). In some examples, events do not correspond to anything obviously related to security. For instance, events can be benign.

An incident (or security incident) can be information that indicates the possibility that a security attack has occurred and/or is currently occurring. Unlike a security threat, which is about the future, an incident is about the past and present. An incident can include evidence of faulty play, an alert triggered by a system that detects malicious, suspicious or anomalous activity. Incidents can be investigated to determine if a security attack actually took place (in many cases an incident can be a false positive) and the root causes (e.g., what vulnerabilities and exploits were used).

An alert (or security alert), as used herein, can include an event that indicates the possibility of an attack. For instance, an intrusion detection system of a participant entity 104 and/or the threat management platform 102 can look for behaviors that are known to be suspicious and generate an event to that effect. Such an event (e.g., an alert) can have a priority associated with it to indicate how likely it is to be a security attack and/or how dangerous the observed behavior was.

Security context can include information that describes something about the participant (e.g., participant characteristic data), the overall threat level or score of a security occurrence, something about an individual or local threat environment, information about the global threat environment of the threat exchange community (e.g., increased activity of a particular type), and/or other useful information. Said differently, a security context describes and/or is the security-related conditions within the threat exchange community. As examples, a security context can describe or account for a security threat level within the threat exchange community, a qualitative assessment of the security attacks and/or security threats within the threat exchange community, activity and/or events within the threat exchange community, the IT infrastructure within the threat exchange community, incidents within the threat exchange community, information provided by a threat exchange server, information collected by a participant of the threat exchange community, and/or other security-related information. As a specific example, a security context can be defined by security occurrences within a threat exchange community. That is, the security context of a participant or the threat exchange community can be determined based on security occurrences identified within the threat exchange community.

The communication engine 120 can be used to receive threat information (e.g., threat observable) from one or more of the entities 104 and/or threat submitter 108. Threat information can be considered information that can be used to help determine a threat. The respective threat information about the threat observables respectively include at least one attribute about a respective threat associated with the threat observable. Examples of threat observables include IP addresses, domains, file hashes, etc. The communication engine 120 can be implemented using logic, circuitry, and/or processors. An example of a communication engine 120 can include a network interface card.

The share engine 122 can provide data about the respective threat information. In some examples, the data can be processed from the received threat information. In other examples, the data can be the threat information. The threat information can be provided to a plurality of the entities 104. In one example, the entities 104k-104n are a member of at least one community based on a set of rules 254. One of the rules 254 can indicate that the data is to be shared to the community(ies) 140. Even though FIG. 1 shows a single community 140, additional communities can be used for purposes of the disclosure described herein.

The entity database 250 can include information about the respective entities 104a-104n (e.g., policies associated with the respective entities, characteristic data, associated categories, associated groups, associated attributes, etc.). The threat data 252 can include information about threat observables (e.g., events, patterns, identification tools, associated threat scores, etc.). The rules 254 can include who of the entities in the entity database 250 to share with. In some examples, a rule can say to share information with the public. In other examples, the rule can say to share with a particular community, such as community 140. Moreover, rules can be customized. Further, in certain examples, when a threat submitter 108 submits threat information (e.g., in the form of a threat observable), information can be included that directs the threat management platform 102 to determine which of the rules 254 to use. For example, the threat submitter 108 can be associated with rules to share the information with one or more of a plurality of communities (including public and private communities).

In one scenario, community 140 is selected by a rule. In some examples, community 140 may include more than one private communities. The community 140 can be considered a private community where information is shared to other members of the community. In this scenario, the members can include entities 104k-104n.

A release identification engine 124 can determine that one of the data submitted has been released outside of the entities. As noted, this can be determined using multiple approaches. For example, the threat data can be found in another community run by the threat management platform 102, the threat data may be found in a blog crawled by the threat management platform 102, the threat data may be received as part of feed information subscribed to by the threat management platform 102, the threat data may be found using another resource, etc. The identification can be based on a correlation of the data from the resource and/or other community and the data submitted and/or sent to the community 140. The community may have an expectation or policy that the information shared to the community is not to be shared outside. Further, in one example, the determination that the data has been released outside of the community 140 can be based on a submission by another threat submitter outside of the community including the data, information received from another source outside of the community including the data, combinations thereof, etc.

A pattern engine 126 can be used to determine that the data is part of a pattern of release associated with the community 140. The pattern can be a correlation between the providing of the shared threat information and the appearance of the threat data at another location outside of the entities 104. For example, if the information is shared to the community at a particular time and found at the location at later on a regular basis. Regularity can be determined based on one or more rules or policies and can be customized (e.g., found at location (e.g., website, feed, etc.) at between X and Y time after providing the information to the community 140).

The remediation engine 128 can be used to perform a remedial action based on the determination of the pattern. In certain examples, the remedial action can include at least one of: a notifying the identified potential source of the release, removal of the potential source from the community (either permanently or on a provisionary basis), restricting access to the threat information to the potential source, notifying the threat submitter of the possible leak, and other remedial actions. Remedial action can be considered an action to lessen or remove the impact of the release and/or to make it less likely for the release to happen again.

The communication network 106 can use wired communications, wireless communications, or combinations thereof. Further, the communication network 106 can include multiple sub communication networks such as data networks, wireless networks, telephony networks, etc. Such networks can include, for example, a public data network such as the Internet, local area networks (LANs), wide area networks (WANs), metropolitan area networks (MANs), cable networks, fiber optic networks, combinations thereof, or the like. In certain examples, wireless networks may include cellular networks, satellite communications, wireless LANs, etc. Further, the communication network 106 can be in the form of a direct network link between devices. Various communications structures and infrastructure can be utilized to implement the communication network(s).

By way of example, the security management platforms 130a-130n and threat management platform 102 communicate with each other and other components with access to the communication network 106 via a communication protocol or multiple protocols. A protocol can be a set of rules that defines how nodes of the communication network 106 interact with other nodes. Further, communications between network nodes can be implemented by exchanging discrete packets of data or sending messages. Packets can include header information associated with a protocol (e.g., information on the location of the network node(s) to contact) as well as payload information.

A processor 230, such as a central processing unit (CPU) or a microprocessor suitable for retrieval and execution of instructions and/or electronic circuits can be configured to perform the functionality of any of the engines/modules described herein. In certain scenarios, instructions and/or other information, such as entity data and/or threat data, can be included in memory 232 or other memory. Input/output interfaces 234 may additionally be provided by the threat management platform 102. For example, input devices 240, such as a keyboard, a sensor, a touch interface, a mouse, a microphone, etc. can be utilized to receive input from an environment surrounding the threat management platform 102. Further, an output device 242, such as a display, can be utilized to present information to users. Examples of output devices include speakers, display devices, amplifiers, etc. Moreover, in certain embodiments, some components can be utilized to implement functionality of other components described herein. Input/output devices such as communication devices like network communication devices or wireless devices can also be considered devices capable of using the input/output interfaces 234.

Each module (not shown) may include, for example, hardware devices including electronic circuitry for implementing the functionality described herein. In addition or as an alternative, each module may be implemented as a series of instructions encoded on a machine-readable storage medium of threat management platform 102 and executable by processor 230. It should be noted that, in some embodiments, some modules are implemented as hardware devices, while other modules are implemented as executable instructions.

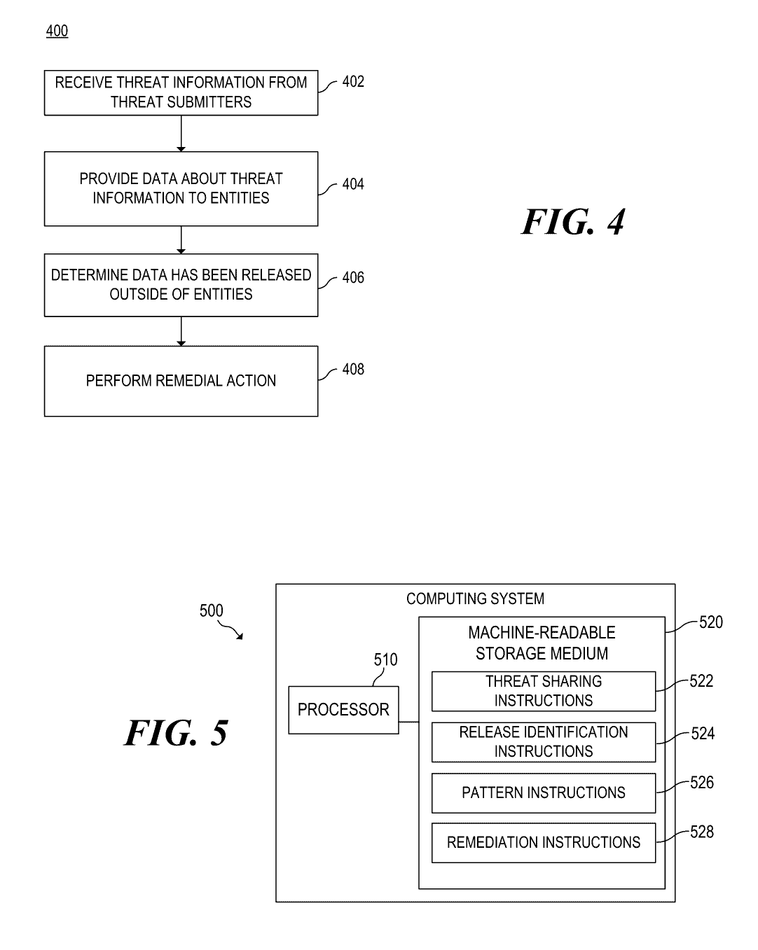

FIG. 4 is a flowchart of a method for performing a remedial action based on release of threat data, according to one example. Although execution of method 400 is described below with reference to computing system 500, other suitable components for execution of method 400 can be utilized (e.g., threat management platform 102). Additionally, the components for executing the method 400 may be spread among multiple devices. Method 400 may be implemented in the form of executable instructions stored on a machine-readable storage medium, such as storage medium 520, and/or in the form of electronic circuitry.

FIG. 5 is a block diagram of a computing system capable of remediating a release of threat data, according to one example. The computing system 500 includes, for example, a processor 510, and a machine-readable storage medium 520 including instructions 522, 524, 526, 528 for performing a remedial action in response to a release of threat data. Computing system 500 may be, for example, a notebook computer, a desktop computer, a server, a workstation, or any other computing device or system capable of performing the functionality described herein.

Processor 510 may be, at least one central processing unit (CPU), at least one semiconductor-based microprocessor, at least one graphics processing unit (GPU), other hardware devices suitable for retrieval and execution of instructions stored in machine-readable storage medium 520, or combinations thereof. For example, the processor 510 may include multiple cores on a chip, include multiple cores across multiple chips, multiple cores across multiple devices (e.g., if the computing system 500 includes multiple node devices), or combinations thereof. Processor 510 may fetch, decode, and execute instructions 522, 524, 526, 528 to implement the approaches described herein. As an alternative or in addition to retrieving and executing instructions, processor 510 may include at least one integrated circuit (IC), other control logic, other electronic circuits, or combinations thereof that include a number of electronic components for performing the functionality of instructions 522, 524, 526, 528.

Machine-readable storage medium 520 may be any electronic, magnetic, optical, or other physical storage device that contains or stores executable instructions. Thus, machine-readable storage medium may be, for example, Random Access Memory (RAM), an Electrically Erasable Programmable Read-Only Memory (EEPROM), a storage drive, a Compact Disc Read Only Memory (CD-ROM), and the like. As such, the machine-readable storage medium can be non-transitory. As described in detail herein, machine-readable storage medium 520 may be encoded with a series of executable instructions for performing method 400 and/or 600.

At 402, the computing system 500 can receive threat information from a respective plurality of threat submitters. As noted previously, the threat submitters can be part of one or more communities. A community may include a plurality of entities. For example, a community may include a plurality of individuals (i.e., entities) in a particular area of interest. A community may include a global community where any entity may join, for example, via subscription. A community may also be a vertical-based community. For example, a vertical-based community may be a healthcare or a financial community. A community may also be a private community with a limited number of selected entities. In some examples, information provided to a private community may not be expected to be provided outside of the community.

At 404, threat sharing instructions 522 can be used to share data about the respective threat information is provided to entities based on a set of rules. In one example, a rule can indicate that the data is to be shared at one or more communities. These communities can be private communities. Further, in some examples, the rules can also indicate that the threat information should not be shared outside of the one or more communities. The one or more communities can include the entities that the information is shared to. As noted, the threat submitter can set the rule and/or the rule can be set based on a policy associated with the community. In some examples, one of the rules of the set can specifically indicate that the threat information of a threat submitter is not to be shared outside of one or more communities that includes the entities.

At 406, release identification instructions 524 can be executed by the processor 510 to determine that the data has been released outside of the entities. In one example, the determination that the data has been released outside of the entities is based on information received from another source outside of the at least one community including the data. The other source can include, for example, a threat information feed, crawling of a website to determine that the data is found outside, etc.

In another example, the source can be another threat submitter who is not associated with the community. A submission by another threat submitter outside of the one or more communities including the data can indicate that the information got released from the community to the threat submitter somehow.

In some examples, pattern instructions 526 can be executed to determine that the data is part of a pattern of release associated with the community. The releases may be considered unauthorized. The pattern can be based on an analysis of the released data with sharing to the community (e.g., X time after the share, Y data is released at location Z). Various processes can be used to detect a pattern within the information about the releases.

At 408, remediation instructions 528 can be executed to perform a remedial action based on the release of the data. The remedial action can further be based on the detection of the pattern of releases. In one example, as part of the remedial action, the computing system 500 can determine whether the data was shared by the threat submitter that submitted the information to a location of the release (e.g., a blog, another member of the threat exchange community outside of the private community, etc.). If the information was allowed to be shared by the threat submitter, further remediation may not be necessary because it was shared by the source. If not, the remedial action can include identifying a source of the leak. In one example, this can be considered a leak because it would be against a rule or policy to share the information outside of the community. In one example, after confirming that the release was unauthorized, the identification occurs.

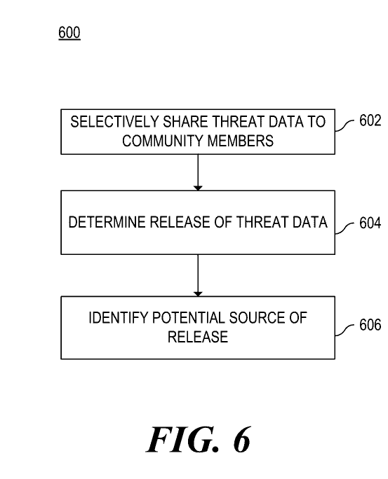

The remedial action can be based on identification of a potential source of the release of the data, which is further described in FIG. 6. In some examples, the remedial action can include notifying the identified potential source of the release that there may be a leak, removing the potential source from the community, restricting access to threat information to the potential source, combinations thereof, etc.

FIG. 6 is a flowchart of a method for identifying a potential source of release of threat data, according to one example. Although execution of method 600 is described below with reference to computing system 500, other suitable components for execution of method 600 can be utilized (e.g., threat management platform 102). Additionally, the components for executing the method 600 may be spread among multiple devices. Method 400 may be implemented in the form of executable instructions stored on a machine-readable storage medium, such as storage medium 520, and/or in the form of electronic circuitry.

After a release of data, other information can come in through submitters to the private community(ies) that may have issues with leaks. As such, further information can be received about threats. To find a possible leaker, at 602, the computing system 500 can selectively share new threat data to the community members. In one example, the new threat data can be provided to a portion of the entities in the community(ies). Then, at 604, the computing system 500 can determine release of the new threat data. This can be narrowed down to the portion that received the new threat data. That group can further be provided newer threat data until, at 606, a potential source of the release is identified.

In one example, the new threat data is actual threat data submitted. Iterations of selective shares can be used to narrow down and identify the potential source of the leak. This can be implemented as a process of elimination.

In another example, the computing system can generate tainted threat information. The tainted threat information can be selectively shared to the entities. If there is release of the tainted threat information, then the entities that received the tainted threat information can be considered the potential source of the leak. In some examples, each entity is provided different tainted information. In other examples, process of elimination can be used. As noted above, providing entities partial information of a complete multi-part attack can also be used in a similar manner as taint.

What is claimed is:

1. A non-transitory machine-readable storage medium storing instructions that, if executed by at least one processor of a computing system, cause the computing system to:
receive threat information from a respective plurality of threat submitters;
provide data about the respective threat information to a plurality entities based on a set of rules;
determine that one of the data has been released outside of the entities; and
perform a remedial action based on the release of the one data.

2. The non-transitory machine-readable storage medium of claim 1, wherein one of the rules of the set indicates that the one of the data of a first one of the threat submitters is to be shared to at least one community that includes the entities.

3. The non-transitory machine-readable storage medium of claim 2, further comprising instructions that, if executed by the at least one processor, cause the computing system to:
as part of the remedial action, determine whether the one data was shared by the first one threat submitter to a location of the release.

4. The non-transitory machine-readable storage medium of claim 3, further comprising instructions that, if executed by the at least one processor, cause the computing system to:
based on a determination that the first one threat submitter did not share the one data:
receive further threat information from the plurality of threat submitters corresponding to sharing with the at least one community;
selectively share the respective another data about the further threat information with the one or more entities;
determine that another release of one of the further threat information was associated with a first one of the entities; and
identify at least one potential source of the other release based on a process of elimination.

5. The non-transitory machine-readable storage medium of claim 4, wherein the remedial action includes at least one of notifying the identified at least one potential source of the release, removing the at least one potential source from the community, and restricting access to threat information to the at least potential source.

6. The non-transitory machine-readable storage medium of claim 3, further comprising instructions that, if executed by the at least one processor, cause the computing system to:
based on a determination that the first one threat submitter did not share the one data:
generate tainted threat information;
selectively share the respective tainted threat information the one or more entities;
determine that another release of one of the respective tainted threat information was associated with a first one of the entities; and
identify at least one potential source of the other release based on taint of the other release.

7. The non-transitory machine-readable storage medium of claim 2, wherein the remedial action is further based on a determination of a pattern of release is associated with the at least one community.

8. The non-transitory machine-readable storage medium of claim 1, wherein one of the rules of the set indicates that one of the threat information of a first one of the threat submitters is not to be shared outside of one or more communities that includes the entities, and the determination that the one data has been released outside of the entities is based on a submission by another threat submitter outside of the one or more communities including the one data.

9. A method comprising:
receiving threat information from a respective plurality of threat submitters;
providing data about the respective threat information to a plurality entities based on a set of rules including a rule that indicates that the data is to be shared at least one community,
wherein the at least one community includes the entities;
determining that one of the data has been released outside of the entities;
determining that the one data is part of a pattern of release associated with the at least one community; and
performing a remedial action based on the release of the one data and the determination of the pattern.

10. The method of claim 9, wherein the determination that the one data has been released outside of the entities is based on a submission by another threat submitter outside of the at least one community including the one data.

11. The method of claim 9, wherein the determination that the one data has been released outside of the entities is based on information received from another source outside of the at least one community including the one data.

12. The method of claim 11, wherein the other source includes at least one of: a threat information feed and crawling of a website.

13. A threat management platform comprising:
a communication engine to receive threat information from a respective plurality of threat submitters,
a share engine to provide data about the respective threat information to a plurality entities that are a member of at least one community based on a set of rules including a rule that indicates that the data is to be shared at the least one community,
wherein the at least one community includes the entities;
a release identification engine to determine that one of the data has been released outside of the entities;
a pattern engine to determine that the one data is part of a pattern of release associated with the at least one community; and
a remediation engine to perform a remedial action based on the determination of the pattern.

14. The threat management platform of claim 13, wherein the remedial action includes at least one of: the communication engine being caused to notify the identified at least one potential source of the release, removal of the at least one potential source from the community, and restricting access to the threat information to the at least potential source.

15. The threat management platform of claim 13, wherein the determination that the one data has been released outside of the entities is based on at least one of: a submission by another threat submitter outside of the at least one community including the one data; and information received from another source outside of the at least one community including the one data.
